(19) United States
(12) Patent Application Publication
(10) Pub. No.: US 2004/0037920 A1
(43) Pub. Date: Feb. 26, 2004

(54) Cheese-making method

(76) Inventors: Alain Choulet, Vandome (FR); Jean-Paul Gaulier, Soulge Sur Ouette (FR)

Correspondence Address: YOUNG & THOMPSON, 745 SOUTH 23RD STREET 2ND FLOOR, ARLINGTON, VA, 22202

(21) Appl. No.: 10/433,419

(22) PCT Filed: Dec. 21, 2001
(86) PCT No.: PCT/FR01/04172

(30) Foreign Application Priority Data
Dec. 26, 2000 (FR) 00/17061

(51) Int. Cl. A23C 9/12

(52) U.S. Cl. 426/36

(57) ABSTRACT

The invention concerns a method for making cheese products having a living flora, characterised in that it comprises the following steps: a) providing a mixture comprising not less than 10% of at least a process cheese and not more than 90% of at least a natural cheese having a dry extract more than 45%; b) heat treatment at a temperature less than 90° C. and mechanical treatment under low shearing, to obtain limited destructuring of the protein structure of the resulting cheese mass; c) shaping the cheese obtained at the preceding step, optionally before or after cooling the cheese mass; and d) packaging the resulting product.

The invention relates to a process for making novel cheese products by treating a starting material consisting of a mixture of at least two cheeses, including a processed cheese and to the products obtained by this process.

Cheese products are already known which are obtained by treating raw materials obtained from treating milk.

The most representative family of this category of products is that of processed cheeses, the latter being obtained by grinding any category of cheeses obtained from milk, more specifically pressed cheeses, mixing with other dairy raw materials (milk powder) semiskimmed or skimmed, butter, anhydrous fat, protein concentrates, and the like) in variable quantity according to the type of finished products which it is desired to obtain, optionally incorporating into said mixture emulsifying salts chosen from the family of sodium, potassium or calcium polyphosphates, orthophosphates or citrates, and then heat-treating the mixture at temperatures between 80 and 140° C. for a period ranging from a few seconds to several minutes according to the temperature used.

However, such a process leads to a type of cheese which, in spite of a nutritional value equivalent to the products used, a possibility of varied presentations (portions, slices, blocks and the like) and an excellent preservation (longer than that of the initial product) is completely different from the original product both in the texture thereof (production of a homogeneous emulsion), and in the taste thereof (flavor loss due to the heat treatment, different flavor perception because of the formulation and the structural modifications of the products).

There may also be mentioned the process described in Patent Application WO 95/19 669 which relates to a treatment of cooked pressed cheeses, which are substandard or in pieces, the process described consisting in dividing the raw material into pieces of regular shape, in subjecting the divided cheese, without addition of water or of any other ingredient, to blending and controlled shearing operations and to cooking at a temperature between 70 and 80° C., preferably in a cooker-extruder type apparatus. However, the temperatures used in this process are not without consequence on the state of the proteins which they destructure and they cause flavor loss.

Moreover, the process is applied to a particular category of cheeses, namely cooked pressed cheeses, with a particular piece of equipment (cooker-extruder) under precise conditions of use (temperatures greater than 70° C.).

However, the work carried out by the inventors who are the authors of the present invention has shown that heat treatments above the pasteurization temperature, that is above 70° C., cause denaturation of the product. At these temperatures, the texture of the products is closer in theological terms to that of a processed cheese than that of a natural cheese.

Thus, for processed cheeses, analysis of the level of peptization indicating a change in the structure of proteins during the process, measured by the level of nonsedimentable nitrogen linked to the release of soluble proteins during the manufacturing treatment, indicates a value between 40 and 50 when the heat treatment is above 100° C. whereas these values are close to 0 for cheeses which have not been subjected to any treatment.

In order to avoid the disadvantages of a change in the texture and taste of the cheeses linked to high heat treatments, the authors of the present invention proposed treating cheeses at temperatures below the pasteurization temperature, in order to produce novel products having a texture and a taste close to the starting materials.

There may be mentioned EP 260 194 which describes the production of a cheese product by mechanical treatment at a temperature between 40 and 50° C. of a pressed cheese having solids content of at least 50%, to which an emulsifying agent, in particular whey proteins, is added in order to solve the problem of the stability of the emulsion. The process described is however limited to treatment of cheeses having a solids content greater than 50%.

The applicant itself proposed in FR 2 778 821 treating a raw material consisting of a cheese having a solids content of not less than 40%, to which a mechanical and heat treatment of the kneading type is applied, the temperature being not more than 65° C. The document describes that it is possible to add to the cheese a quantity of water of not less than 7%, and of not more than 20% by weight.

However, this process applies more particularly to the treatment of pressed cheeses, and cannot apply, in any case, to soft cheeses or fromage frais because of the lower solids content leading to the destruction of the structure of the paste and to restructuring difficulties.

Moreover, while the abovementioned treatments apply without any problem to pressed cheeses which are characterized by high solids contents and by mineralized cheese pastes and by good cohesion, they cannot apply to cheeses of other categories such as soft cheeses or fromage frais having a lower solids content (less than 45-50%), scarcely mineralized and having a weak cohesion.

Indeed, the treatment of cheeses according to the processes designated above leads to “slurry” or textures of the “semolina” type, and it is impossible to restructure the paste without the involvement of emulsifying agents.

Some authors have focused on solving this problem by treating a mixture of cheeses of various origins.

There may thus be mentioned patent EP 535 728 which describes the production of cheese products obtained by treating a mixture of raw materials of various origins at a temperature below the pasteurization temperature, that is 35 to 65° C. The mixture consists of 30 to 90% of an unripened cheese having a solids content greater than 40% and a paste based on ripened cheeses such as Cheddar and/or another source of protein (milk protein concentrates or flavoring cheese concentrates), it being necessary for this second source to give taste to the finished product. However, the products obtained, in particular those obtained from the use of moist raw materials or from formulas with a high water content have nonhomogeneous textures of the “semolina” type because of the relatively large quantity of unripened cheese used.

In order to solve the problem of the “semolina” texture of the finished products, the authors of EP 948 897 describe a treatment at temperatures below the pasteurization temperature (20-65° C.) of a mixture consisting of a ripened cheese and an unripened cheese, the proportion of ripened cheeses being greater than 30%. However, the objective of this process is the manufacture of cheese spreads and not of elastic hard cheeses which can be cut, chewed, sliced, and the like.

The latter two processes relate, in general, to treatments at temperatures below the pasteurization temperature of cheese products of a mixture of natural cheeses obtained from milk, more specifically ripened cheeses having a solids content greater than 50% and fromage frais (solids content greater than 40%) or scarcely ripened cheeses with as an objective to reproduce in the finished product organoleptic characteristics (taste in particular) similar to those of the ripened cheeses used.

None of the processes mentioned above envisaged carrying out a treatment of the type described above of a mixture containing processed cheeses despite the advantages at the bacteriological and organoleptic level (range of taste) while conferring on the finished product an elastic, malleable texture, but sufficiently firm so that it can be sliced or chewed, as encountered in natural cheeses, in particular pressed cheeses.

Unexpectedly, the authors of the present invention have shown that by mixing at least one processed cheese or one processed preparation obtained by processing cheeses with at least one “natural” cheese having a solids content greater than 45%, the proportion by weight of processed cheese being not less than 10%, and by mechanically treating under low shearing the mixture obtained at a temperature below the pasteurization temperature, novel products with a homogeneous, elastic, supple and pleasant texture are obtained which may exhibit organoleptic characteristics (taste, flavors) close to either of the starting raw materials.

Moreover, the use of processed cheese or processed preparation in the mixture to be treated has undeniable advantages from the point of view of food safety and preservation of the products. Thus, the processed cheese obtained by cheese processing is more stable than the original cheese having a shorter shelf life.

Moreover, the use of processed cheese in the starting formula has advantages on the production in terms of:

quality of raw materials, in particular in terms of food safety (bacteriological safety and stability),

preservation versus a limited shelf life of the original products availability: possibility of transfer

simplicity, ease of use (absence of preparation steps).

The subject of the present invention is thus a process for manufacturing cheese products having a living flora, characterized in that it comprises the following steps:

a) producing a mixture comprising not less than 10% of at least one processed cheese and not more than 90% of at least one natural cheese having a solids content greater than 45%;

b) heat treatment at a temperature below 70° C. and mechanical treatment under low shearing, for obtaining a limited destructuring of the protein network of the cheese mass obtained;

c) shaping the cheese mass obtained in the preceding step, optionally before or after cooling the cheese mass; and

d) packaging the product obtained.

The expression “natural” cheeses is understood to mean the products obtained by treating milk, whether the latter is cow's, goat's, sheep's or buffalo's milk, and the like.

For their production, the starting milk is standardized or otherwise with respect to the proteins and fats, pasteurized or otherwise and coagulated, either by the action of coagulating agents such as rennet or its substitutes, or by inoculating the milk with lactic acid bacteria until the isoelectric point of casein (pH=4.6) is obtained, or by the combined action of the preceding two modes, drained, shaped, brined and optionally pressed and/or ripened by the action of a specific ripening flora which is allowed to develop under optimum conditions in cheese ripening rooms until the desired organoleptic characteristics are obtained.

Depending on the nature of the milk, the mode of coagulation, the presence or otherwise of a ripening step, an extensive range of starting materials is obtained which is classified into fromage frais (lactic coagulation, little or no ripening, low solids content (generally less than 40%)), soft cheeses (mixed coagulation, draining and optionally ripening, solids content greater than the above (greater than 35-40% but generally less than 50%)) and pressed cheeses (rennet coagulation, pressing and often ripening, and high solids content, greater than 45%).

Moreover, all these cheeses are characterized by the presence of microorganisms in the paste and, optionally, at the surface, in the case of cheeses with a natural rind, which makes these products “live”, that is to say evolving over time like any “natural” cheese.

In the context of the invention, pressed cheeses are preferably used as “natural” cheeses.

The expression “processed” cheeses or processed cheese specialities is understood to mean the products obtained by processing, under heat treatment and generally under a partial vacuum, cheeses in the presence or otherwise of emulsifying salts. The raw materials used are preferably pressed cheeses but any type of natural cheese as defined above is also appropriate. It is also possible to use “curds” with a rennet or lactic character.

Moreover, it is possible to add to the formula skimmed or unskimmed milk powder, butter, AMF (anhydrous milk fat), whey powder or protein concentrates in liquid or powdered form. It is possible to partially or completely replace the milk fat with vegetable fat and the proteins with vegetable proteins. The formula may also comprise texturing agents such as hydrocolloids. The use of the latter is advantageous when moist raw materials (low solids content) are used to obtain products having a very supple texture. The manufacture of processed cheese is perfectly described in the book by ECK and GILLIS J. C., A: “Le fromage”, 3rd edition, Ed. Lavoisier Paris, to which reference may be made for further details.

In the context of the invention, the processed cheese or the processed cheese preparation is prepared according to traditional techniques by processing cheeses of just one category, or of a mixture of varieties according to the taste characteristics which it is desired to obtain.

Moreover, the starting cheese raw material depends on the organoleptic characteristics which is desired to confer on the cheese or on the processed cheese raw material or on the final product. Thus, for example, in the case where it is desired to confer on the final product organoleptic characteristics (taste and flavors) of soft products of the Camembert type, a processed cheese is prepared from the processing of Camembert.

In a preferred mode of the invention, the cheese raw material to be processed will be chosen from the family of soft cheeses with a natural rind, fromage frais or lactic or rennet fresh curds or the mixture of these components.

There may be mentioned for the starting cheeses, soft cheeses with a white rind such as Brie or Camembert, blue-veined cheeses such as Gorgonzola and Roquefort, cheeses with a colored rind such as Munster and Maroilles, pressed cheeses such as Gouda, Edam, Cantal, Emmental, Maasdam and old or young Cheddar.

The expression “low shearing” is understood to mean stresses not greater than those exerted in a “cutter” type piece of equipment at speeds of up to 1200 rpm.

There may be mentioned, for example the treatments carried out in commercial apparatus of the cutter type (for example those marketed under the name STEPHAN®) traditionally used in the production of prepared meat products or in the manufacture of processed cheese revolving at speeds of between 250 and 1200 rpm, advantageously 300 and 600 rpm; apparatus of the kneader, mixer, blender, cooker-mixer, co-blender, and extruder type are also appropriate.

The destructuring of the protein network is measured by analyzing the level of peptization indicating a change in the structures of the proteins during treatment, the latter is expressed by the level of nonsedimentable soluble nitrogen linked to the release of the soluble peptides during the manufacturing treatment. The values should not be greater than 80% of the initial value of the mixture of cheeses.

It should be observed that the processed cheese paste exhibits high destructuring of its protein network compared with the original cheese from which it is derived. Because of this, a proportion of destructured protein network is due to the addition of the processed cheese and will depend on the quantity of processed cheese introduced into the mixture.

The maximum values of 80% indicated above are given for the proportion of cheese other than the processed cheese.

Advantageously, the starting mixture comprises from 10 to 80% by weight, and preferably 10 to 50% by weight of at least one processed cheese

It is also preferable that the natural cheese having a solids content greater than 45% represents from 10 to 90%, and advantageously from 20 to 90% by weight of the mixture of cheeses.

It is also possible to add to the mixture of cheeses a quantity of water generally less than 20%, so as to adjust the final solids content of the product.

According to another advantageous characteristic of the process of the invention, the heat treatment is carried out at 70° C. and is maintained for a period of between 30 seconds and 6 minutes. The maximum temperatures indicated above are given for a pressure equal to or less than atmospheric pressure.

Advantageously, the mixture of step b) is cooled to a temperature of less than 60° C. (at atmospheric pressure) at the end of the heat and mechanical treatment step and then shaped by any appropriate means such as casting, proportioning or molding.

As a variant, the product obtained at the end of the mechanical and heat treatment may be shaped by any appropriate means as mentioned above and then cooled to a temperature of less than 60° C.

Moreover, the cooling step may be carried out in two stages. Thus, at the end of the heat and mechanical treatment step, the product may be cooled in a first instance to a temperature of less than 60° C. and then shaped by any traditional means, it being possible for the two steps to be reversed; and then the product obtained may, in a second instance, be cooled to a temperature of less than 15° C. (at atmospheric pressure).

It is also possible to add to the mixture before mechanical treatment, depending on the final product which it is desired to obtain:

fat in various forms (butter, anhydrous milk fat, vegetable fat) according to the fat content of the desired final product;

functional ingredients: hydrocolloids, and the like,

flavoring ingredients, inclusions in the form of formed elements, (walnuts, hazelnuts, olives, herbs, and the like) or any other desired food ingredients such as trace elements or vitamins.

Flavoring substances and various ingredients may be optionally added at this stage of manufacture.

The process according to the invention will be understood more clearly with the aid of the description which follows:

In a step (1), the size of the natural cheese(s) entering into the base mixture optionally after derinding is reduced by grating and/or grinding of the “natural” cheese(s). The products used may be low in lipids, low in sodium, and the like. In parallel, the processed cheese is cut into cubes of side 1 to 10 cm or grated like natural cheese. The processed cheese is advantageously, but not exclusively, prepared from soft or blue-veined cheeses, rennet or lactic curds or fromage frais such as feta, and the like.

In a step (2), mixing is carried out with the desired proportions of cubed (or grated) processed cheese and preferably grated “natural” cheese of step (1). It is possible to use one or more “natural” cheeses and one or more processed cheeses in the mixture according to the final organoleptic characteristics which it is desired to obtain. The level in the mixture of the natural cheese(s) is between 10 and 90% by weight and that of the processed cheese(s) is between 10 and 80%, preferably 10 and 50% by weight. It is possible to add to the mixture of cheeses an additional quantity of water in order to adjust the final solids content of the product, this quantity of water not being greater than 20% by weight, and fat in order to obtain the desired content of fat in the final product.

It is also possible to add to the starting mixture formed food elements of plant or animal origin in a proportion of 1 to 10% by weight relative to the weight of the mixture of cheeses. These elements may be added at the time of mixing the cheese constituents or after the step of heating so as not to break them. More advantageously and for food safety reasons, they may be incorporated into the processed cheese preparation. It is also possible to subject, after the cooling step, the paste obtained to an overrun treatment by incorporating nitrogen or any other compatible and appropriate gas with the aid of a customary overrun-producing apparatus. In this case, the paste is not subjected to mechanical treatment and it is packaged after shaping in a mold or in the final wrapping. This treatment confers a more aerated texture on the product.

By adjusting the formulation during the preparation of the processed cheese, in particular the type of cheese used, the type of “natural” cheese(s) used and the processed cheese/“natural” cheese ratio in the mixture, it is possible to obtain a broad range of products in terms of taste, flavor and texture, characteristics which can be adjusted on demand while retaining either close or distant characteristics of the starting natural cheeses.

It is thus possible to design cheeses with a pressed cheese texture and a soft cheese taste or a fresh taste.

It is thus possible to design cheeses with a pressed cheese texture of the “Tomme de Savoie” type and a soft cheese taste of the Camembert, Brie or Chèvre type or having a fresh taste of the “cheese in cheese drainers” type. Indeed, the texture and the flavoring qualities of the cheese are no longer conferred by the manufacturing technology (for example, pressing) nor the action of ripening flora, but by the mixing in a greater or lesser quantity of the cheese raw material(s) of which it is desired to recover the organoleptic qualities (texture and/or flavors in the finished product).

Thus, it is possible to manufacture a cheese having both a supple texture of a cheese of the Saint Paulin type using in particular a young and scarcely flavoring Saint Paulin and a taste of soft cheese with washed rind of the Munster type mixed with the young Saint Paulin, a processed cheese obtained by processing a cheese with washed rind which will confer on the finished product its taste and flavor qualities.

In a step (3), the mixture is subjected to a heat treatment at a temperature not more than 70° C. and a mechanical treatment of the kneading type. This step is carried out by subjecting the mixture to a gentle heat treatment consisting in heating the starting material to a temperature between 20° C. and 70° C. under the action of moderate shearing and in maintaining the mixture at this temperature for a period of between 30 seconds and 3 minutes while mixing the paste in order to produce a homogeneous mixture. This step may be carried out in a cutter, a kneader or any other suitable apparatus (extruder). The rate of mixing in a cutter or kneader is advantageously between 250 and 1500 rpm, preferably between 300 and 600 rpm.

In a step (4), the paste obtained in step (3) is shaped before and/or after cooling to a temperature below 60° C., according to the Theological properties of the paste in order to make it appropriate for shaping, and which depend on the mode of shaping used: conventional proportioning, casting or molding.

The products leaving the shaping device exist in varied forms (beads, spheres, parallelepipeds, cylinders, eggs, cubes, and the like).

Advantageously, insofar as the shaping is carried out by conventional molding in cheese-making, the product placed in the mold may be subjected to a mild operation of pressing in order to stabilize the shape of the product.

If the cooling step has not been carried out before shaping, it is then carried out at this stage of the process.

The product is then packaged in any appropriate packaging of the sachet, box, shell, aluminum foil type or coated with cheesemaking waxes or substitutes thereof such as acetoglycerides or edible coatings.

The products obtained are of every shape and of every size. The latter is advantageously between 1 and 500 g. They have a supple, homogeneous and elastic texture which can be sliced, cut or even chewed depending on the type of consumption desired. However, the texture of the products obtained does not make it possible to spread them. They may have a reduced content of fats or of salts, be enriched with vitamins or trace elements, and the like. Like “natural” cheeses, they also contain living microorganisms which continue to develop throughout the marketing cycle. The total flora of the products is generally between 10⁵ and 10⁸ bacteria/gram of cheese depending on the nature of the raw materials used, their age and the treatment temperature.

The invention is illustrated by the examples below given by way of illustration and without limitation.

For understanding them, reference will be made to the accompanying figures in which:

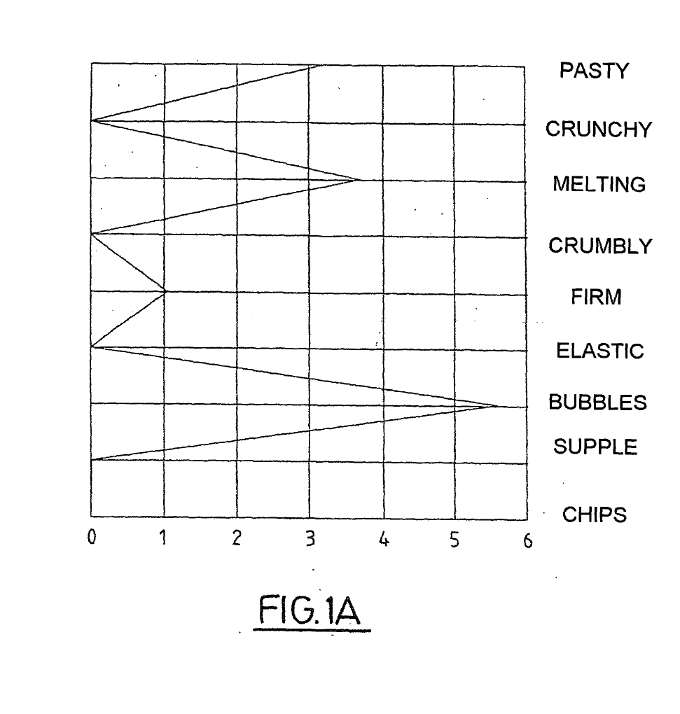

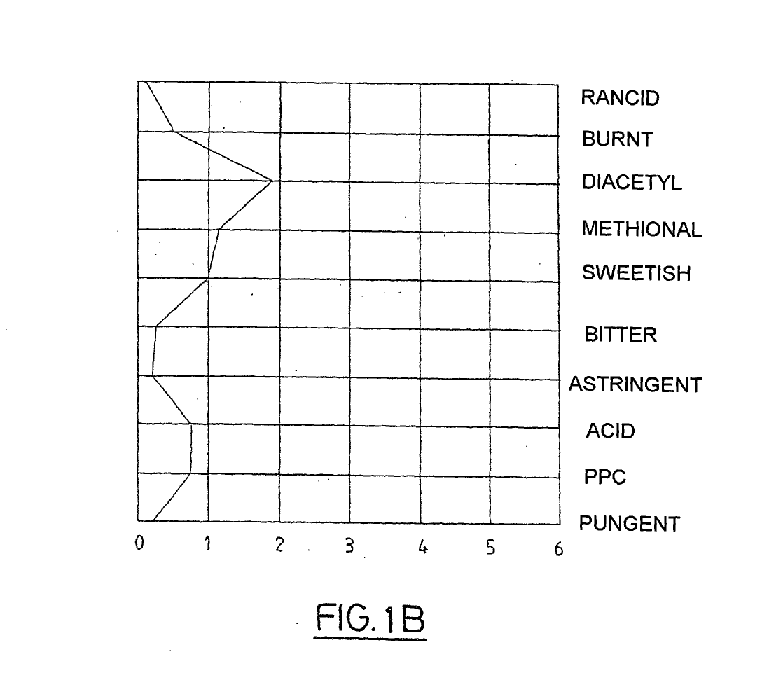

FIG. 1 represents the results of sensory analysis of products obtained according to Example 1;

FIG. 1A represents the results of analysis of the texture, the results being expressed by a score ranging from 0 to 6 according to the following criteria: pasty, crunchy, melting, crumbly, firm, elastic, supple, presence of bubbles, presence of chips;

FIG. 1B represents the results of flavor analysis, the results being expressed by a score ranging from 0 to 6 according to the following criteria: rancid, burnt, presence of diacetyl (milk flavoring compound characteristic of the flavor of butters), sweetish or bitter character, astringent, acid and pungent character;

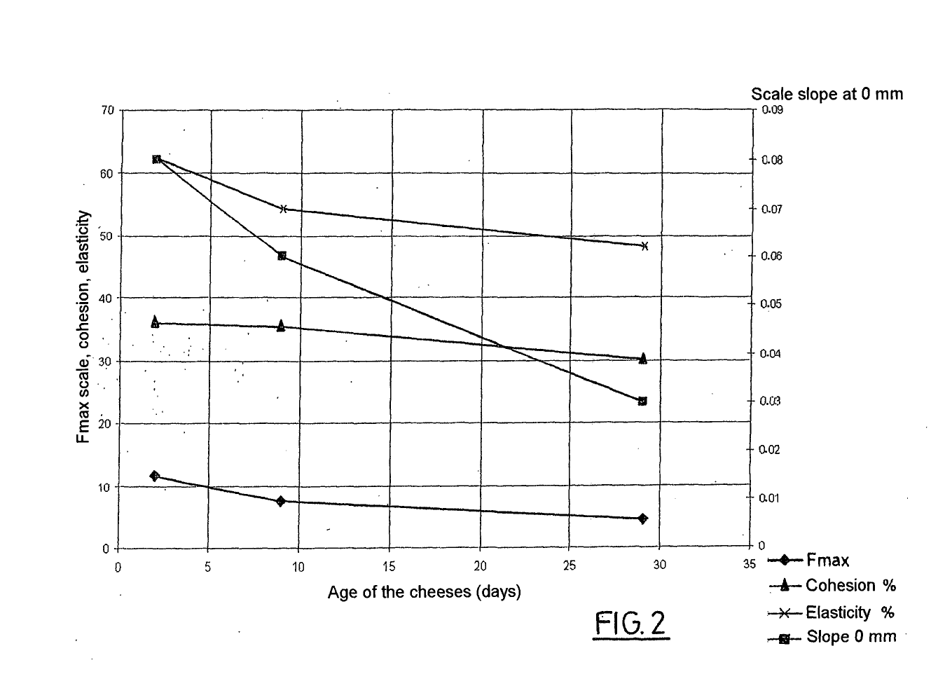

FIG. 2 represents a diagram illustrating the results of analysis in double compression of the products manufactured according to Example 1, during the first stages of aging,

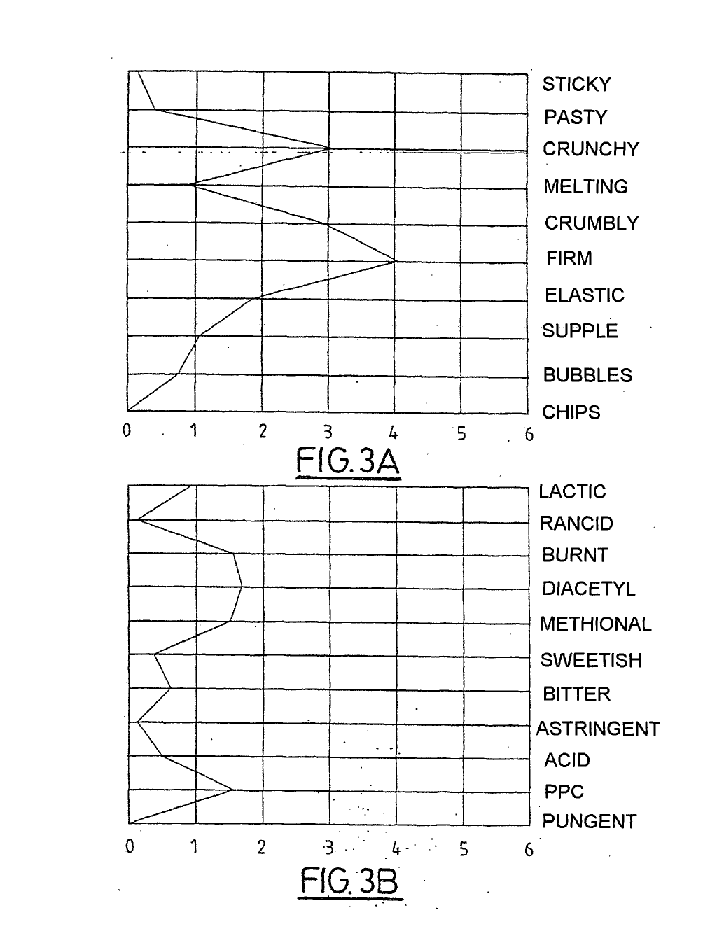

FIG. 3 represents a diagram illustrating the results of sensory analysis of products obtained according to Example 3;

FIG. 3A represents the results of analysis of the texture;

FIG. 3B represents the results of analysis of the flavor.

### EXAMPLES

### Example 1

### Manufacture of a Small-Size Product with a Supple and Melting Texture and with a Sweet and Creamy Taste, from a Mixture of Natural Cheeses and Processed Camembert.

The following formula is used:

TABLE 1
Formula intended for the manufacture of a
small-sized product with a supple and melting texture.

| | Pro- | |
|---|---|---|
| Raw materials | portion | Preparation |
| Young pressed cheese of | 40% | Grated into strands |
| the Saint Paulin type | | (section 1 mm * 2 mm) |
| Processed cheese obtained | 40% | Cut into cubes of side |
| by processing Camembert | | 40 mm approximately |
| (with emulsifying salts) | | |
| Young Cheddar | 14% | Grated into strands |
| Anhydrous milk fat | 5% | Melted at 46° C. |
| Mineral water | 2% | |
| Salt | 1% | Dispersed in water |

The processed cheese is manufactured according to known technologies (for example, see “le fromage”, A. Eck, ed. Lavoisier).

The mixture is introduced into a stirring-mixing chamber under moderate shearing, at controlled pressure (for example a cutter). The mixture is heated by direct injection of steam, with moderate stirring (400 rpm), to a temperature of 45 to 50° C., and then maintained at this holding temperature, with moderate stirring (400 rpm), for 40 seconds. The paste thus produced is then stirred under reduced shearing (200 rpm), for 210 seconds, the chamber being maintained under a partial vacuum (0.7×10⁵ Pa).

The paste obtained is discharged into an appropriate container and subjected to static cooling in a refrigeration chamber. Once sufficiently firm, the paste is poured into a preshaping apparatus in which two large diameter contrarotating screws press the paste against a perforated drum, thus giving them a hemidiscoidal shape having a straight edge.

The pieces thus formed, of about 20 g, are then pressed in suitable molds so as to give them their final shape, and then cooled in a refrigeration chamber at low temperature. The products are unmolded in the cold state and then packaged in an impervious packaging.

The products obtained have a supple, unctuous and slightly melting texture. Their taste is sweet and creamy. Their physicochemical characteristics are the following:

TABLE 2
Physicochemical analyses of the products
obtained according to the technique presented above:

| | Solids | Fat on a | | |
|---|---|---|---|---|
| Analyses | content | dry basis | pH | NaCl |
| Product 188-1 | 48.9 | 54.2 | 5.95 | 1.7 |

The finished product has a total flora of 5×10⁶ bacteria/g of cheese.

Tasting of the products by an expert panel gives the results illustrated in FIG. 1.

The products are also analyzed in double compression (Instron apparatus, level of compression of 50%, speed 50 mm/min, core of diameter 17 mm and height 11 mm), at three successive ages. The following results are obtained:

TABLE 3
Double compression analyses of the products
obtained according to the technique presented above:
The results are illustrated in FIG. 2.

| Age | | | Cohesion*** | Elasticity**** |
|---|---|---|---|---|
| (days) | Fmax*(N) | Slope** 0 mm | % | % |
| 2 | 11.6 | 0.08 | 36.2 | 62.2 |
| 9 | 7.57 | 0.06 | 35.6 | 54.5 |
| 29 | 4.47 | 0.03 | 30.2 | 48.3 |

*Fmax: maximum force presented by the cheese to the probe during the first compression.
**slope 0 mm: slope of the curve in the first moments following probe/cheese contact.
***cohesion: ratio of the energy of the second compression to the energy of the first.
**** elasticity: percentage of recovery of the cheese height after the second compression.

### Example 2

### Manufacture of a Small-Size Product with the Taste of Munster, from a Mixture of Pressed Cheeses and Processed Munster

The following formula is used:

TABLE 4
Formula intended for the manufacture of a
small-size product with the taste of Munster

| | Pro- | |
|---|---|---|
| Raw materials | portion | Preparation |
| Young pressed cheese of | 40% | Grated into strands |
| the Saint Paulin type | | (section 1 mm * 2 mm) |
| Processed cheese obtained | 40% | Cut into cubes of side |
| by processing ripened | | 40 mm approximately |
| Munster (with emulsifying | | |
| salts) | | |
| Young Cheddar | 14% | Grated into strands |
| Anhydrous milk fat | 5% | Melted at 46° C. |
| Water | 1% | |

The processed cheese is manufactured according to known technologies (for example, see “le fromage”, A. Eck, ed. Lavoisier).

The mixture is introduced into a stirring-mixing chamber under moderate shearing, at controlled pressure (for example a cutter). The mixture is heated by direct injection of steam, with moderate stirring (400 rpm), to a temperature of 43 to 47° C., and then maintained at this holding temperature, with moderate stirring (400 rpm), for 40 seconds. The paste thus produced is then stirred under reduced shearing (200 rpm), with cooling using a jacket, for 210 seconds, the chamber being maintained under a partial vacuum (0.7×10⁵ Pa).

The paste obtained is discharged into an appropriate container and allowed to stand. Once sufficiently firm, the paste is poured into a pre-shaping apparatus in which two large diameter contrarotating screws press the paste against a perforated drum, thus giving them a hemidiscoidal shape having a straight edge.

The pieces thus formed, of about 20 g, are then pressed in suitable molds so as to give them their final shape, and then cooled in a refrigeration chamber at low temperature. The products are unmolded in the cold state and then packaged in an impervious packaging.

The products obtained have a supple and slightly pasty texture, and a sharp taste of Munster. Its physicochemical characteristics are the following:

TABLE 5
Physicochemical analyses of the products
obtained according to the technique presented above:

| | Solids | Fat on a | | |
|---|---|---|---|---|
| Analyses | content | dry basis | pH | NaCl |
| Product | 50.1 | 54 | 6.01 | 2.1 |

### Example 3

### Manufacture of a Small-Size Product Having a Fruity Taste, from a Mixture of Propionic Fermentation and Semicooked Pressed Cheeses, and of Processed Young Pressed Cheese

The following formula is used:

TABLE 6
Formula intended for the manufacture of a
small-size product having a taste of the cooked pressed
cheese type.

| | Pro- | |
|---|---|---|
| Raw materials | portion | Preparation |
| Maasdam | 85% | Grated into strands |
| | | (section 1 mm * 2 mm) |
| Unripened pressed | 15% | Grated into strands |
| processed cheese | | (section 1 mm * 2 mm) |

The processed cheese is produced in a cooker-extruder type apparatus, without the addition of functional ingredients.

The mixture is introduced into a stirring-mixing chamber under moderate shearing, at controlled pressure (for example a cutter). The mixture is heated by direct injection of steam, with moderate stirring (450 rpm), to a temperature of 54 to 58° C., and then maintained at this holding temperature, with moderate stirring (450 rpm), for 40 seconds. The paste thus produced is then stirred under reduced shearing (200 rpm), for 120 seconds, the chamber being maintained under a partial vacuum (0.7×10⁵ Pa).

The paste obtained is poured into a pre-shaping apparatus in which two large diameter contrarotating screws press the paste against a perforated drum, thus giving them a hemidiscoidal shape having a straight edge.

The pieces thus formed, of about 20 g, are then pressed in suitable molds so as to give them their final shape, and then cooled in a refrigeration chamber at low temperature. The products are unmolded in the cold state and then packaged in an impervious packaging.

The products obtained have a texture which is fairly firm, moderately elastic, crunchy, very scarcely melting, and neither sticky nor pasty. Their taste is essentially of the cooked pressed cheese type, and slightly burnt and lactic. Its physicochemical characteristics are the following:

TABLE 7
Physicochemical analyses of the products
obtained according to the technique presented above:

| | Solids | Fat on a | | |
|---|---|---|---|---|
| Analyses | content | dry basis | pH | NaCl |
| Product 201-2 | 53.1 | 47.5 | 5.76 | 1.5 |

Tasting of the products by an expert panel gives the results illustrated in FIG. 3, the analysis is expressed in the form of a score from 0 to 6 according to various parameters as for FIG. 1.

### Example 4

### Manufacture of a Small-Size Product Having a Creamy Taste, from Pressed Cheeses and Fromage Frais-Processed Cheese

The following formula is used:

TABLE 8
Formula intended for the manufacture of a
small-size product with a supple and melting texture

| | Pro- | |
|---|---|---|
| Raw materials | portion | Preparation |
| Gouda | 80% | Grated into strands |
| | | (section 1 mm * 2 mm) |
| Fromage frais- | 20% | Cut into cubes of side |
| processed cheese | | 40 mm approximately |

The fromage frais-processed cheese is manufactured according to traditional technologies from curd (for example, cf. “le fromage”, A. Eck, ed. Lavoisier), and packaged in a large volume.

The mixture is introduced into a stirring-mixing chamber under moderate shearing, at controlled pressure (for example a cutter). The mixture is heated by direct injection of steam, with moderate stirring (400 rpm), to a temperature of 52 to 56° C., for 50 seconds, and then maintained at the holding temperature, with moderate stirring (400 rpm), for 40 seconds. The paste thus produced is then stirred under reduced shearing (200 rpm), for 300 seconds, the chamber being maintained under a partial vacuum (0.7×10⁵ Pa).

The paste obtained is poured into a pre-shaping apparatus in which two large diameter contrarotating screws press the paste against a perforated drum, thus giving them a hemidiscoidal shape having a straight edge.

The pieces thus formed, of about 20 g, are then pressed in suitable molds so as to give them their final shape, and then cooled in a refrigeration chamber at low temperature. The products are unmolded in the cold state and then packaged in an impervious packaging.

The products obtained have a moderately firm texture and a slightly melting and pasty texture. Their taste is sweet, creamy, lactic and slightly acid. Its physicochemical characteristics are the following:

TABLE 9
Physicochemical analyses of the products
obtained according to the technique presented in
Example 4:

| | Solids | Fat on a | | |
|---|---|---|---|---|
| Analyses | content | dry basis | pH | NaCl |
| Product | 51.5 | 53.5 | 5.7 | 1.5 |

### Example 5

### Manufacture of a Low-Fat Small-Size Product Having an Edam-Type Taste

The following formula is used:

TABLE 10
Formula intended for the manufacture of a
low-fat small-size product having an Edam-type taste

| | Pro- | |
|---|---|---|
| Raw materials | portion | Preparation |
| Low-fat ripened Edam (32% | 68% | Grated into strands |
| fat on a dry basis) | | (section 1 mm × 2 mm) |
| Pressed processed cheese | 26% | Grated into strands |
| with a low fat level (20% | | (section 1 mm × 2 mm) |
| fat on a dry basis) | | |
| Quark (0% fat on a dry | 4% | Incorporate among the |
| basis) | | grated cheese grains |
| Water | 2% | |

The processed cheese is produced according to the technologies traditionally used, so as in particular to increase the capacity of the mixture of the pressed cheese having a low fat level (fat on a dry basis ˜20%, solids ˜40).

The mixture is introduced into a stirring-mixing chamber under moderate shearing, at controlled pressure (for example a cutter). The mixture is heated by direct injection of steam, with stirring, to a temperature of 48 to 56° C. and then maintained at the holding temperature, with moderate stirring, for 40 seconds. The paste thus produced is then stirred under reduced shearing, for 300 seconds, the chamber being maintained under a partial vacuum (0.7×10⁵ Pa).

The paste obtained is poured into a pre-shaping apparatus in which two large diameter contrarotating screws press the paste against a perforated drum, thus giving them a hemidiscoidal shape having a straight edge.

The pieces thus formed, of about 20 g, are then pressed in suitable molds so as to give them their final shape, and then cooled in a refrigeration chamber at low temperature. The products are unmolded in the cold state and then packaged in an impervious packaging.

The products obtained have a texture which is fairly supple and very slightly granular. Their taste is sweet, resembling that of a cooked and lactic pressed cheese. Its physicochemical characteristics are the following:

TABLE 11
Physicochemical analyses of the products
obtained according to the technique presented in
Example 6:

| | Solids | Fat on a | | |
|---|---|---|---|---|
| Analyses | content | dry basis | pH | NaCl |
| Product | 44 | 28.9 | 5.6 | 1.6 |

1. A process for manufacturing cheese products having a living flora, characterized in that it comprises the following steps:
a) producing a mixture comprising not less than 10% of at least one processed cheese and not more than 90% of at least one natural cheese having a solids content greater than 45%;
b) heat treatment at a temperature below 70° C. and mechanical treatment under low shearing, for obtaining a limited destructuring of the protein network of the cheese mass obtained;
c) shaping the cheese mass obtained in the preceding step, optionally before or after cooling the cheese mass; and
d) packaging the product obtained.

2. The process as claimed in claim 1, characterized in that the mixture comprises from 10 to 90%, advantageously from 10 to 50% by weight of at least one processed cheese.

3. The process as claimed in claim 1, characterized in that the mixture comprises from 10 to 90%, advantageously from 20 to 90% by weight of at least one natural cheese having a solids content greater than 45%.

4. The process as claimed in one of claims 1 to 3, characterized in that the mixture comprises from 0 to 20% by weight of added water.

5. The process as claimed in one of claims 1 to 4, characterized in that the mechanical treatment is carried out in a cutter-type apparatus with a mixing speed of between 250 and 1200 rpm, preferably 300 and 600 rpm.

6. The process as claimed in one of claims 1 to 4, characterized in that the mechanical treatment is carried out in a blender, cooker-mixer, mixer, co-blender or extruder.

7. The process as claimed in one of claims 1 to 6, characterized in that the heat treatment is maintained for a period of between 30 seconds and 6 minutes.

8. The process as claimed in one of claims 1 to 7, characterized in that the mixture of step b) is cooled to a temperature of less than 60° C., and then shaped by casting, proportioning or molding.

9. The process as claimed in one of claims 1 to 8, characterized in that the mixture of step b) is shaped by casting, proportioning or molding, and then cooled to a temperature of less than 60° C.

10. The process as claimed in one of claims 1 to 9, characterized in that the product obtained in step b) is shaped by traditional molding by the hand and then cooled to a temperature of less than 15° C.

11. The process as claimed in one of claims 1 to 10, in which ingredients of plant or animal origin other than a cheese and/or flavorings are incorporated into the mixture.

12. The process as claimed in one of claims 1 to 11, in which additional fat of animal or plant origin is added to the starting mixture.

13. The process as claimed in one of claims 1 to 8, characterized in that the starting cheese raw materials are optionally derinded, grated into strands, ground or cut into pieces of size between 1 and 10 cm.

14. The process as claimed in one of claims 1 to 8, in which an overrun of the cheese paste is produced after the cooling step.

15. A cheese product of homogeneous, elastic or plastic texture, capable of being sliced or chewed, obtained according to claims 1 to 14.
